(19) United States
(12) Patent Application Publication
(10) Pub. No.: US 2015/0120836 A1
(43) Pub. Date: Apr. 30, 2015

(54) APPARATUS FOR PROVIDING MIND MAP-TYPE ONLINE COMMUNITY SERVICE

(71) Applicant: SAMSUNG SDS CO., LTD., Seoul (KR)

(72) Inventors: Ja Wook KOO, Seoul (KR); Sae Hyung KWON, Seoul (KR); Han Joo SONG, Seoul (KR); Seung Min BAEK, Suwon-si (KR)

(73) Assignee: SAMSUNG SDS CO., LTD., Seoul (KR)

(21) Appl. No.: 14/529,654

(22) Filed: Oct. 31, 2014

(30) Foreign Application Priority Data
Oct. 31, 2013 (KR) 10-2013-0130965

(51) Int. Cl. H04L 12/24; H04L 29/08

(52) U.S. Cl. CPC H04L 41/12; H04L 67/10
USPC 709/204

(57) ABSTRACT

Exemplary embodiments of the invention provide an apparatus for providing a mind map-type online community service, capable of maintaining the “theme-wise” direction of conversations by forming nodes in a shape with a protrusion in response to content being created by a user.

This application claims priority to Korean Patent Application No. 10-2013-0130965 filed on Oct. 31, 2013 in the Korean Intellectual Property Office, the disclosure of which is incorporated herein by reference in its entirety.

### BACKGROUND

1. Field of the Invention

The invention relates to an apparatus for providing a mind map-type online community service, and more particularly, to an apparatus for providing a mind map-type online community service, capable of improving the performance of a mind map-type online community service for users.

2. Description of the Related Art

In a mind map-type online community service, users may easily lose track of or get confused with, the themes and flows of conversations and the directions of figures of a mind map, especially when the number of figures of the mind map increases in response to the users using the online community service together to write and edit messages.

That is, in a case in which a conversation is continued in the form of in a radial structure, users may not be able to properly identify where the conversation is being headed. To solve this problem, arrows may be used. However, even with the use of arrows, it may still be difficult to adequately determine the direction of the conversation. Since arrows are often not seen on an enlarged screen, arrows may not be much helpful for grasping the flow of the conversation, especially when users read, for example, messages, by expanding the radial structure.

Therefore, a method is needed to address the above and other problems.

### SUMMARY

Exemplary embodiments of the invention provide an apparatus for providing a mind map-type online community service, capable of maintaining the “theme-wise” direction of conversations by forming nodes in a shape with a protrusion in response to content being created by a user.

Exemplary embodiments of the invention also provide an apparatus for providing a mind map-type online community service, capable of providing route information corresponding to a shortest route from a node selected by a user to a central node on a mind map-type online community.

Exemplary embodiments of the invention also provide an apparatus for providing a mind map-type online community service, capable of providing information relating to one or more nodes created by the same creator as a node selected by a user on a mind map-type online community.

Exemplary embodiments of the invention also provide an apparatus for providing a mind map-type online community service, capable of skipping the display of content in nodes of less importance when there are many nodes created.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, an apparatus for providing a mind map-type online community service having a central node, which includes content, and one or more lower nodes, which are directly or indirectly connected to the central node and include content related to the content of the central node, includes: a node shape generation unit configured to generate a shape in which to visually provide the lower nodes to a user, wherein in response to the lower nodes including a first lower node directly connected to the central node and an (n+1)-th lower node directly connected to an n-th lower node, the node shape generation unit is further configured to form the first lower node in a shape with a first direction indicator, which protrudes from the first lower node toward the central node, and to form the (n+1)-th lower node in a shape with an (n+1)-th direction indicator, which protrudes from the n-th lower node toward the central node.

According to another exemplary embodiment of the invention, an apparatus for providing a mind map-type online community service having a central node, which includes content, and one or more lower nodes, which are directly or indirectly connected to the central node and include content related to the content of the central node, includes: a route information unit configured to in response to a selection of one of the lower nodes being received from a user, provide the user with route information corresponding to a route from the selected lower node to the central node, wherein the route information corresponds to a route from the selected lower node to the central node that involves a minimum number of intervening lower nodes.

According to another exemplary embodiment of the invention, an apparatus for providing a mind map-type online community service having a central node, which includes content, and one or more lower nodes, which are directly or indirectly connected to the central node and include content related to the content of the central node, includes: a display skipping unit, wherein if the lower nodes includes a plurality of first lower nodes directly connected to the central node and a plurality of (n+1)-th lower node directly connected to a plurality of n-th lower nodes, respectively, the display skipping unit is configured to in response to the number of first lower nodes exceeding a predefined value, calculate the importance of each of the plurality of first lower nodes according to a predefined set of rules, select a number of first lower nodes from the plurality of first lower nodes based on the calculated importance of each of the plurality of first lower nodes and skip the display of content in non-selected first lower nodes, and also configured to in response to the number of (n+1)-th lower nodes exceeding the predefined value, calculate the importance of each of the plurality of (n+1)-th lower nodes according to the predefined set of rules, select a number of (n+1)-th lower nodes from the plurality of (n+1)-th lower nodes based on the calculated importance of each of the plurality of (n+1)-th lower nodes and skip the display of content in non-selected (n+1)-th lower nodes.

According to another exemplary embodiment of the invention, an apparatus for providing a mind map-type online community service having a central node, which includes content, and one or more lower nodes, which are directly or indirectly connected to the central node and include content related to the content of the central node, includes: a creator-specific information providing unit configured to in response to a selection of a node from the central node and the lower nodes and a selection of a creator of the selected node being received from the user, provide the user with other nodes that are also created by the creator of the selected node.

According to the exemplary embodiments, the “theme-wise” direction of conversations can be maintained while providing a user with a mind map-type online community service.

Also, route information corresponding to a shortest route between a node selected by the user and a central node can be provided. Accordingly, the user can easily recognize the direction to the central node and choose between nodes.

Also, in response to a node being selected by the user, various information such as information relating to other nodes that are also created by the creator of the selected node can be provided.

Also, the display of content in nodes of less importance can be display-skipped, and as a result, the user can easily identify the content of conversations or messages and the general flow of a mind map-type online community.

Other features and exemplary embodiments will be apparent from the following detailed description, the drawings, and the claims.

### BRIEF DESCRIPTION OF THE DRAWINGS

FIG. 1 is a diagram illustrating an example of a mind map-type online community that may be created by multiple users through the use of a mind map-type online community service according to an exemplary embodiment of the invention.

FIG. 2 is a diagram of an apparatus for providing a mind map-type online community service, according to an exemplary embodiment of the invention.

FIG. 3 is a schematic diagram illustrating an example of a node shape that may be generated by a node shape generation unit illustrated in FIG. 2.

FIG. 4 is a diagram illustrating the generation of a first direction indicator in a first lower node by the node shape generation unit.

FIG. 5 is a diagram illustrating an example of a display screen via which route information is provided to a user by a route information unit route information unit illustrated in FIG. 2.

FIG. 6 is a diagram illustrating an example of nodes that are display-skipped.

### DETAILED DESCRIPTION OF THE EMBODIMENTS

Advantages and features of the invention and methods of accomplishing the same may be understood more readily by reference to the following detailed description of exemplary embodiments and the accompanying drawings. The invention may, however, be embodied in many different provides and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The invention is applicable to an apparatus and method for providing a mind map-type online community service, and provides technology for providing a variety of convenient functions to users and allowing users to easily identify the flow and direction of conversations.

Examples of the apparatus and method for providing a mind map-type online community service, to which the invention is applicable, will be understood with reference to Korean Patent No. 10-1270070.

A mind map may include a central node and one or more lower nodes connected to the central node.

The central node is a node where a mind map-type online community begins, and which has content such as pieces of writing, documents, images, music items, from which the theme of conversations starts, and may be created by a user who uses a mind map-type online community service.

The lower nodes are nodes connected to the central node and having content relating to the central node. The lower nodes may be created by the user who has created the central node, or other users.

The lower nodes may include all nodes connected to the central node directly or indirectly through one or more other lower nodes, such as, for example, a first lower node directly connected to the central node, a second lower node connected to the first lower node, and a third lower node connected to the second lower node.

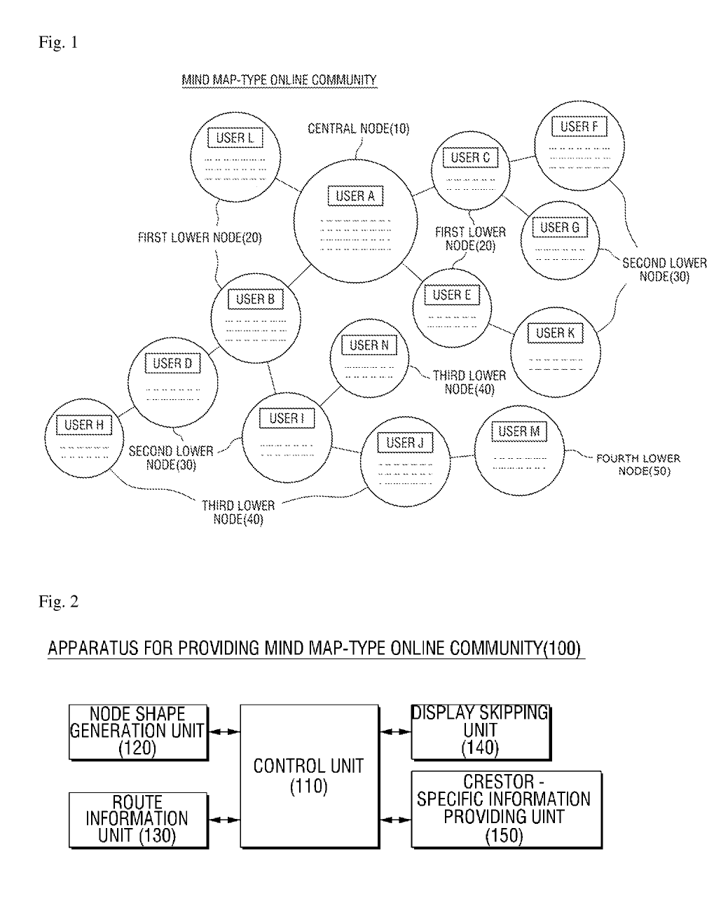

FIG. 1 is a diagram illustrating an example of a mind map-type online community that may be created by multiple users through the use of a mind map-type online community service, according to an exemplary embodiment of the invention.

Referring to FIG. 1, in a mind map-type online community according to an exemplary embodiment of the invention, there are a central node 10 created by user A and a plurality of lower nodes connected to the central node 10, i.e., first lower nodes 20, second lower nodes 30, third and lower nodes 40.

Lower nodes directly connected to the central node 10 are referred to as first lower nodes 20. In FIG. 1, nodes created by users B, C, E and L, respectively, are first lower nodes 20.

Lower nodes directly connected to the first lower nodes 20 are referred to as second lower nodes 30. In FIG. 1, nodes created by users D, F, G, I and K, respectively, are second lower nodes 30.

Lower nodes directly connected to the second lower nodes 30 are referred to as third lower nodes 40. In FIG. 1, nodes created by users H, J and N, respectively, are third lower nodes 40.

Lower nodes directly connected to the third lower nodes 40 are referred to as fourth lower nodes 50. In FIG. 1, a node created by user M is a fourth lower node 50.

That is, a lower node directly connected to an n-th lower node is referred to as an (n+1)-th lower node.

Even if assumed that the fourth lower node 50 has been created by user I who is the creator of a second lower node 30, instead of user M, the fourth lower node 50 may still be considered as a fourth lower node 50 because it is directly connected to a third lower node 40.

In an apparatus (or server) for providing a mind map-type online community service, according to an exemplary embodiment of the invention, there may exist more than one mind map-type online community where a central node and one or more lower nodes are provided, as illustrated in FIG. 1.

For a better understanding of the invention, the invention will hereinafter be described, taking as an example a single mind map-type online community including one central node and one or more lower nodes either directly or indirectly connected to the central node.

As already mentioned above, the teaching of Korean Patent No. 10-1270070 is directly applicable to an apparatus for providing a mind map-type online community service, according to an exemplary embodiment of the invention, and vice versa.

FIG. 2 is a diagram of an apparatus for providing a mind map-type online community service, according to an exemplary embodiment of the invention.

Referring to FIG. 2, an apparatus 100 for providing a mind map-type online community service may include a control unit 110, a node shape generation unit 120, a route information unit 130, a display skipping unit 140, and a creator-specific information providing unit 150.

Alternatively, the apparatus 100 may include the control unit 110 and one of the node shape generation unit 120, the route information unit 130, the display skipping unit 140 and the creator-specific information providing unit 150.

The control unit 110 may manage information created by the node shape generation unit 120, the route information unit 130, the display skipping unit 140 and the creator-specific information providing unit 150, and may also manage and control a central node and one or more lower nodes created by multiple users who use a mind map-type online community service.

The node shape generation unit 120 may generate a shape in which to visually provide each lower node to the user.

More specifically, the node shape generation unit 120 may generate a first lower node in such a shape that the first lower node may include a first direction indicator protruded therefrom toward the central node.

The node shape generation unit 120 may also generate a second lower node in such a shape that the second lower node may include a first direction indicator protruded therefrom toward the central node.

That is, the node shape generation unit 120 may generate an (n+1)-th lower node in a shape with a protrusion facing an n-th lower node.

More specifically, the node shape generation unit 120 may generate the (n+1)-th lower node in such a shape that the protrusion of the (n+1)-th lower node face the center of the n-th lower node to which the (n+1)-th lower node is directly connected.

Since the node shape generation unit 120 may generate the (n+1)-th lower node in a shape with a protrusion facing an n-th lower node, the user may enlarge and move a display screen where a mind map-type online community is displayed without losing track of a direction to a central node of the mind map-type online community.

It is noted that one or more of the node shape generation unit, the control unit, the route information unit, creator-specific information providing unit and the display skipping unit may be implemented via a CPU or other hardware processor.

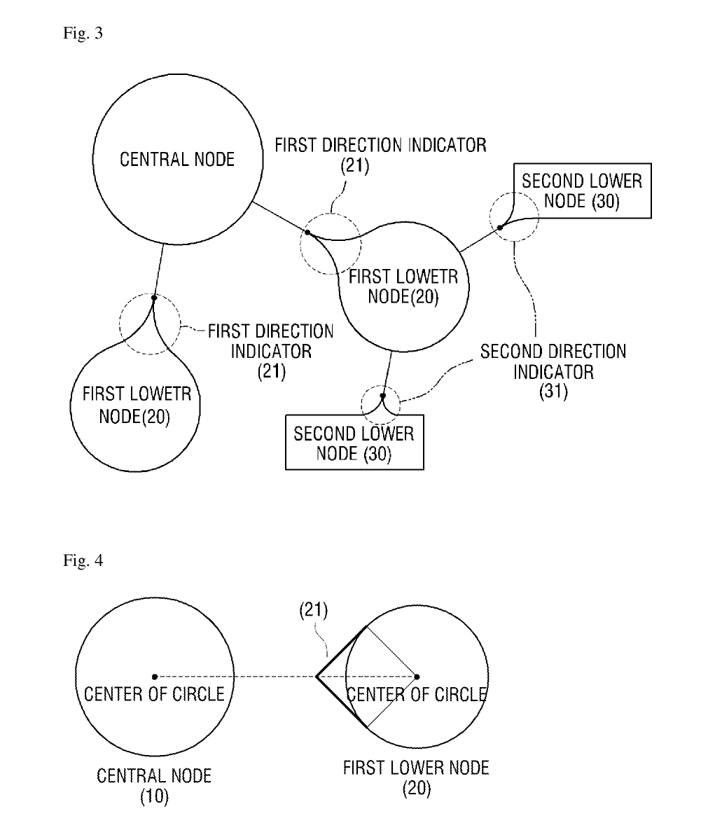

FIG. 3 is a schematic diagram illustrating an example of a node shape that may be generated by the node shape generation unit illustrated in FIG. 2.

Referring to FIG. 3, first direction indicators 21, which protrude from first lower nodes 20, respectively, face a central node.

Second direction indicators 31, which protrude from second lower nodes 30, respectively, face the first lower nodes 20, respectively.

For a distinction between the first lower nodes 20 and the second lower nodes 30, the first lower nodes 20 may be formed in a circular shape, and the second lower nodes 30 may be formed in a rectangular shape.

That is, nodes in the mind map-type online community may have various shapes, such as circular, elliptical, and polygonal shapes. A basic node shape may be a circular shape. For example, the central node 10 may be in a circular shape, and the lower nodes of the central node 10 may all be in the shape of a water drop. Alternatively, a first lower node may have a different shape from a non-first lower node.

FIG. 4 is a diagram illustrating the generation of a first direction indicator in a first lower node by the node shape generation unit illustrated in FIG. 2.

Referring to FIG. 4, in response to a basic node shape being a circular shape, i.e., in response to a central node 10 and a first lower node 20 both being in a circular shape, the node shape generation unit 120 may generate a first direction indicator 21 in such a shape that the apex of the first direction indicator 21 may reside on an imaginary line drawn between the center of the central node 10 and the center of the first lower node 20. Similarly, in response to an n-th lower node and an (n+1)-th lower node both being in a circular shape, the node shape generation unit 120 may generate an (n+1)-th direction indicator in such a shape that the apex of the (n+1)-th direction indicator may reside on an imaginary line drawn between the center of the n-th lower node and the center of the (n+1)-th lower node.

Alternatively, in response to the basic node shape being a rectangular shape, the node shape generation unit 120 may generate the first direction indicator 21 or the (n+1)-th direction indicator in such a shape that the apex of the first direction indicator 21 or the (n+1)-th direction indicator may reside on an imaginary line drawn between the center of gravity of the central node 10 and the center of gravity of the first lower node 20 or from the center of gravity of the (n+1)-th lower node to the center of gravity of the n-th lower node.

However, the invention is not limited to the example illustrated in FIG. 4. That is, the first direction indicator 21 or the (n+1)-th direction indicator may be formed in various shapes other than that set forth in FIG. 4, as long as the first direction indicator 21 or the (n+1)-th direction indicator can properly indicate a direction to the central node 10 or the n-th lower node.

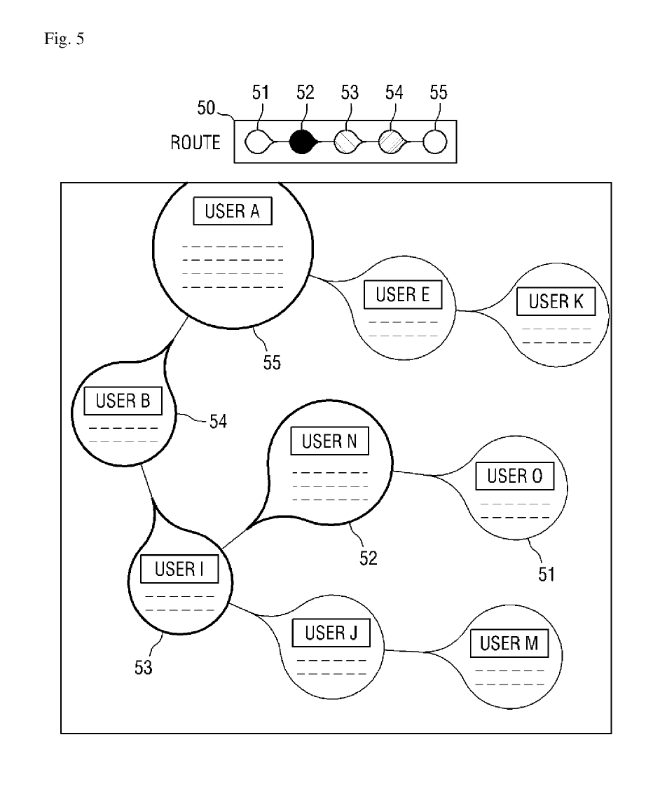

The apex of the first direction indicator 21 or the (n+1)-th direction indicator may be marked at the tip of the corresponding direction indicator, as illustrated in FIG. 3. Alternatively, the apex of the first direction indicator 21 or the (n+1)-th direction indicator may not be marked, and the first direction indicator 21 or the (n+1)-th direction indicator may be formed to have a sharp tip, which will be described later in further detail with reference to FIG. 5.

Referring back to FIG. 2, in response to a selection of a predetermined lower node in the mind map-type online community being received from the user, the route information unit 130 may provide the user with route information indicating a route from the selected node to the central node of the mind map-type online community.

More specifically, the route information unit 130 may provide the user with route information corresponding to a shortest route, which is a route from the selected node to the central node that involves a minimum number of intervening lower nodes therebetween.

The route information unit 130 will hereinafter be described with reference to FIG. 5.

FIG. 5 is a diagram illustrating an example of a display screen via which route information is provided to the user by the route information unit illustrated in FIG. 2.

Referring to FIG. 5, in response to the user selecting a node 52, which is created by user N, from the mind map-type online community, the route information unit 130 may provide route information 5 corresponding to a shortest route from the node 52 and a central node, i.e., a node 54 created by user A. The shortest route between the node 52 and the node 54 may be a route involving a minimum number of intervening lower nodes between the node 52 and the node 54.

The route information unit 130 may display the route information 5 on a display screen, which is provided to the user, particularly, at the top of the display screen, as illustrated in FIG. 5.

Referring further to FIG. 5, in response to the user selecting one node from the route information 5 provided by the route information unit 130, the control unit 110 may change output information of the mind map-type online community such that the node selected from the route information 5 may be located in the middle of the display screen.

That is, if the user selects a node other than the node 52 currently being selected, i.e., a node 54, from the route information 5, the control unit 110 may change the output information of the mind map-type online community such that the node 54 may be located in the middle of the display screen.

Referring further to FIG. 5, the route information unit 130 may display the nodes included in the shortest route between the node 52 and the node 55 in bold outlines for a distinction from other nodes not included in the shortest route between the node 52 and the node 55.

The route information unit 130 may display the nodes in the route information 5 in different shapes, colors, or patterns depending on whether they are first lower nodes, second lower nodes, . . . , or (n+1)-th lower nodes.

The number of nodes that may be displayed in the route information 5 by the route information unit 130 may be determined according to a predetermined setting, and the location of the node selected by the user in the route information 5 may vary according to a predetermined setting.

The display skipping unit 140 will hereinafter be described with reference to FIG. 2.

Referring further back to FIG. 2, in response to there existing more than one first lower node connected to the central node of the mind map-type online community, the display skipping unit 140 may calculate the importance of each of the first lower nodes according to a predefined set of rules, and may skip the display of content in some of the first lower nodes based on the results of the calculation.

Similarly, in response to there existing more than one (n+1)-th lower node connected to an n-th lower node, the display skipping unit 140 may calculate the importance of each of the (n+1)-th lower nodes according to the predefined set of rules, and may skip the display of content in some of the (n+1)-th lower nodes based on the results of the calculation.

The display skipping unit 140 may calculate the importance of a lower node based on the time of the creation of the lower node and the frequency of selection of the lower node by the user and other users who access the mind map-type online community.

In an exemplary embodiment, the display skipping unit 140 may set in advance a number of lower nodes to be display-skipped for each node, i.e., may set in advance how many of a number of lower nodes connected to each node are to be display-skipped. In this exemplary embodiment, the display skipping unit 140 may select a number of lower nodes in order of importance, and may display content in the selected nodes while skipping the display of content in other lower nodes.

The number of lower nodes to be display-skipped may be set differently for first lower nodes and for (n+1)-th lower nodes.

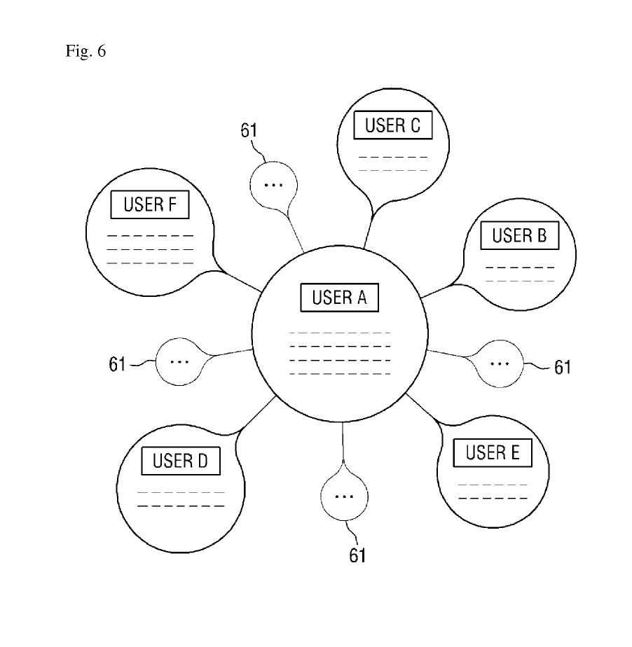

FIG. 6 is a diagram illustrating an example of nodes that are display-skipped. More specifically, FIG. 6 illustrates an example of a display screen that may be displayed to the user.

Referring to FIG. 6, in response to a node created by user A being a central node, nodes that are directly (or primarily) connected to the central node are first lower nodes.

In the example illustrated in FIG. 6, a total of nine first lower nodes are directly connected to the central node, and the maximum number of first lower nodes to be displayed is set in advance to five. The maximum number of first lower nodes 20 to be displayed may not necessarily be set in advance.

Accordingly, four of the nine first lower nodes may be display-skipped as display-skipped first lower nodes 61 by the display skipping unit 140.

The display skipping unit 140 calculates the importance of each of the nine first lower nodes, and makes decisions, based on the results of the calculation, to display content in the first lower nodes created by users B, C, D, E and F, respectively, and to skip the display of content in the other first lower nodes, i.e., the display-skipped first lower nodes 61. The display-skipped first lower nodes 61 may be displayed as illustrated in FIG. 6.

Alternatively, the display-skipped first lower nodes 61 may be collectively displayed as a single node. That is, for an efficient use of display space, the display-skipped first lower nodes 61 may be incorporated into, and displayed as, a single first lower node 61, while in the example illustrated in FIG. 6, the display-skipped first lower nodes 61 are separately displayed.

Referring further to FIG. 6, each of the display-skipped first lower nodes 61 may be displayed with a predetermined symbol, such as “• • •”, to indicate that the content thereof is display-skipped.

Referring further back to FIG. 2, in response to the display skipping unit 140 determining which nodes are to be display-skipped, the control unit 110 may receive and process the results of the determination performed by the display skipping unit 140, and may provide the user with a display screen where content in the nodes that are determined to be display-skipped is not displayed.

Since the display skipping unit 140 skips the display of content in nodes of less importance, the user may easily identify the flows and themes of conversations and messages or pieces of writing of other users' interest in the mind map-type online community.

In response to the user selecting one of the nodes that are display-skipped, the control unit 110 may provide content in the selected node to the user.

The creator-specific information providing unit 150 will hereinafter be described with reference to FIG. 2.

Referring to FIG. 2, in response to a selection of a predetermined node and a selection of the creator of the predetermined node being received from the user, the creator-specific information providing unit 150 may provide the user with one or more other nodes that are also created by the creator of the predetermined node.

More specifically, the creator-specific information providing unit 150 may provide the user with the other nodes created by the creator of the predetermined node in order of time of creation.

In response to the user selecting one of the other nodes created by the creator of the predetermined node, the control unit 110 may provide the user with content in the selected node.

The apparatus 100 can maintain the “theme-wise” direction of conversations while providing the user with a mind map-type online community service.

Also, the apparatus 100 can provide route information corresponding to a shortest route between a node selected by the user and a central node. Accordingly, the user can easily recognize the direction to the central node and choose between nodes.

Also, in response to a node being selected by the user, the apparatus 100 can provide the user with various information such as information relating to other nodes that are created by the creator of the selected node.

Also, the apparatus 100 can skip the display of content in nodes of less importance. As a result, the user can easily identify the content of conversations or messages and the general flow of the mind map-type online community.

The elements of the apparatus 100 may be implemented as software or as hardware such as field-programmable gate arrays (FPGAs) or application-specific integrated circuits (ASICs), but the invention is not limited thereto. That is, the elements of the apparatus 100 may be configured to reside in an addressable storage medium or to execute one or more processors. Each of the elements of the apparatus 100 may be divided into one or more sub-elements such that the functions of the corresponding element can be distributed between the sub-elements, or the elements of the apparatus 100 and the functions thereof may be incorporated into fewer elements.

While the invention has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

What is claimed is:

1. An apparatus for providing a mind map-type online community service, the online community service comprising a central node, which includes a first content, and a plurality of lower nodes, which are directly or indirectly connected to the central node and include second contents related to the first content of the central node, the apparatus comprising:
a node shape generation unit configured to generate shapes according to which the plurality of lower nodes are visually provided,
wherein in a case that the plurality of lower nodes comprises a first lower node directly connected to the central node and a (n+1)-th lower node directly connected to a n-th lower node, the node shape generation unit is further configured to generate the first lower node in a shape with a first direction indicator, which protrudes from the first lower node toward the central node, and to generate the (n+1)-th lower node in a shape with a (n+1)-th direction indicator, which protrudes from the (n+1)-th lower node toward the n-th node.

2. The apparatus of claim 1, wherein the node shape generation unit is further configured to generate the first direction indicator in such a shape that an apex of the first direction indicator is on a line drawn between a center of the central node and a center of the first lower node.

3. The apparatus of claim 1, wherein in a case that the central node and the first lower node are both circular, the node shape generation unit is further configured to generate the first direction indicator in such a shape that an apex of the first direction indicator is on a line drawn between a center of the central node and a center of the first lower node.

4. The apparatus of claim 1, wherein the node shape generation unit is further configured to generate the (n+1)-th direction indicator in such a shape that an apex of the (n+1)-th direction indicator is on a line drawn between a center of the n-th node and a center of the (n+1)-th lower node.

5. The apparatus of claim 1, further comprising:
a route information unit configured to provide route information corresponding to a route from a selected lower node to the central node in response to a selection of one of the lower nodes of the plurality of lower nodes.

6. The apparatus of claim 5, wherein the route information corresponds to a route from the selected lower node to the central node that involves a minimum number of intervening lower nodes.

7. The apparatus of claim 5, further comprising:
a control unit configured to provide the online community service in such a manner that the node selected from the route information is located at about a middle of a display screen in response to the selection.

8. The apparatus of claim 1, further comprising:
a display skipping unit configured, in a case that there exists a plurality of first lower nodes connected to the central node including the first lower node, to calculate the importance of the first lower node according to a predefined set of rules, and to decide whether to display the second content of the first lower node based on the calculated importance of the first lower nodes.

9. The apparatus of claim 8, wherein the display skipping unit is further configured to calculate the importance of the first lower node based on a time of the creation of the first lower node and a frequency of selection of the first lower node.

10. The apparatus of claim 8, wherein the display skipping unit is further configured, in a case that the number of first lower nodes in the plurality of first lower nodes exceeds a predefined value, to select a number of first lower nodes from the plurality of first lower nodes based on the calculated importance of each of the plurality of first lower nodes and to not display the second contents of non-selected first lower nodes.

11. The apparatus of claim 8, wherein in a case that there exists a second node of a plurality of second lower nodes connected to the plurality of first lower nodes, respectively, the display skipping unit is further configured to calculate the importance of the second lower node according to the predefined set of rules and to decide whether to display the second content of the second lower node based on the calculated importance of the second lower node.

12. The apparatus of claim 1, further comprising:
a creator-specific information providing unit configured such that in response to a selection of a node and a selection of a creator of the selected node being received, the creator-specific information providing unit provides other nodes that are also created by the creator of the selected node.

13. The apparatus of claim 12, wherein the creator-specific information providing unit is further configured to provide the other nodes created by the creator of the selected node in order of time of creation.

14. An apparatus for providing a mind map-type online community service, the online community service comprising a central node, which includes a first content, and a plurality of lower nodes, which are directly or indirectly connected to the central node and include second contents related to the first content of the central node, the apparatus comprising:
a route information unit configured to provide route information corresponding to a route from a selected lower node to the central node in response to a selection of one of the lower nodes of the plurality of lower nodes,
wherein the route information corresponds to a route from the selected lower node to the central node that involves a minimum number of intervening lower nodes.

15. An apparatus for providing a mind map-type online community service, the online community service comprising a central node, which includes a first content, and a plurality of lower nodes, which are directly or indirectly connected to the central node and include second contents related to the first content of the central node, the apparatus comprising:
a display skipping unit, wherein in a case that a plurality of first lower nodes are directly connected to the central node, a plurality of (n+1)-th lower nodes are directly connected to a plurality of n-th lower nodes, respectively, and a number of the plurality of first lower nodes exceeds a first predefined value, the display skipping unit is configured to calculate an importance of each of the plurality of first lower nodes according to a predefined set of rules, to select a number of first lower nodes from the plurality of first lower nodes based on the calculated importance of each of the plurality of first lower nodes, and to not display the second contents of a plurality of non-selected first lower nodes from the plurality of first lower nodes, and in the case that a number of the plurality of (n+1)-th lower nodes exceeds a second predefined value, to calculate an importance of each of the plurality of (n+1)-th lower nodes according to the predefined set of rules, to select a number of (n+1)-th lower nodes from the plurality of (n+1)-th lower nodes based on the calculated importance of each of the plurality of (n+1)-th lower nodes, and to not display the second contents of a plurality of non-selected (n+1)-th lower nodes from the plurality of (n+1)-th lower nodes.
